(19) United States
(12) Patent Application Publication
(10) Pub. No.: US 2026/0067188 A1
(43) Pub. Date: Mar. 5, 2026

(54) TRANSMISSION MODE SWITCHING BASED ON A PERFORMANCE INDICATOR

(71) Applicant: Samsung Electronics Co., Ltd., Suwon-si (KR)

(72) Inventors: Tiexing Wang, Melissa, TX (US); Yang Li, Plano, TX (US)

(21) Appl. No.: 19/067,669

(22) Filed: Feb. 28, 2025

Related U.S. Application Data
(60) Provisional application No. 63/687,699, filed on Aug. 27, 2024.

(51) Int. Cl. H04L 43/062; H04B 7/0456; H04L 43/0852; H04L 43/0888

(52) U.S. Cl. CPC H04L 43/062; H04B 7/0456; H04L 43/0852; H04L 43/0888

(57) ABSTRACT

An embodiment includes performing a fast switching between different multiple-input multiple-output (MIMO) modes, including switching between a transmit antenna selection mode and a precoding matrix indicator mode, based on one or more performance indicators in order to determine whether to overwrite a determined MIMO mode, where the performance indicator can be any combination of performance metrics including one or more of a block error rate (BLER), an average outer-loop rate control (OLRC) value, among others.

### CROSS-REFERENCE TO RELATED APPLICATION(S)

This application claims the benefit of priority from U.S. Provisional Application No. 63/687,699, entitled “ROBUST TRANSMISSION MODE ADAPTATION BY FAST RECOVERY FROM INFERIOR MODE” filed Aug. 27, 2024, which is incorporated herein by reference in its entirety.

### TECHNICAL FIELD

This disclosure relates generally to a wireless communication system, and more particularly to, for example, but not limited to, transmission mode switching using one or more performance indicators.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

The description set forth in the background section should not be assumed to be prior art merely because it is set forth in the background section. The background section may describe aspects or embodiments of the present disclosure.

### SUMMARY

One aspect of the present disclosure provides a base station (BS) in a wireless network, comprising: a memory; and a processor coupled to the memory. The processor configured to perform a first switching from a first mode to a second mode. The processor is configured to transmit one or more packets to one or more user equipment (UEs) while operating in the second mode. The processor is configured to determine that performing a second switching is allowed based on i) whether a time period after the first switching is greater than a first threshold or ii) whether a number of packets transmitted from the BS after the first switching is greater than a second threshold. The processor is configured to determine a degradation in packet transmission performance while operating in the second mode based on a performance indicator for a period of time. The processor is configured to perform the second switching to switch from the second mode to the first mode based on determining the degradation in the packet transmission performance and determining that performing the second switching is allowed. The processor is configured to transmit one or more packets to the one or more UEs while operating in the first mode.

In some embodiments, the first mode is a transmit antenna selection mode and the second mode is a precoding matrix indicator mode or ii) the first mode is a precoding matrix indicator mode and the second mode is a transmit antenna selection mode.

In some embodiments, the determining the degradation in the packet transmission performance based on the performance indicator for the period of time comprises: i) determining that a measured throughput after the first switching is lower than a measured throughput before the first switching, ii) a block error rate increases after the first switching, or ii) a predicted throughput of the first mode is greater than a measured throughput of the second mode.

In some embodiments, the processor is further configured to: perform an update to the second mode during a time delay period; and perform the second switching from the second mode to the first mode after the time delay period.

In some embodiments, the time delay period is fixed.

In some embodiments, the time delay period varies based on an amount of the degradation in the packet transmission performance.

In some embodiments, the performance indicator is a block error rate, a measured throughput, or an average outer-loop rate control value.

In some embodiments, the first threshold or the second threshold vary based on a current system load or a traffic type of a user equipment (UE).

In some embodiments, the processor is further configured to: repeatedly check during a time period whether performing the second switching is allowed.

In some embodiments, the period of time is greater than a third threshold.

One aspect of the present disclosure provides a computer-implemented method for wireless communication by a base station (BS) in a wireless network. The method comprises performing a first switching from a first mode to a second mode. The method comprises transmitting one or more packets to one or more user equipment (UEs) while operating in the second mode. The method comprises determining that performing a second switching is allowed based on i) whether a time period after the first switching is greater than a first threshold or ii) whether a number of packets transmitted from the BS after the first switching is greater than a second threshold. The method comprises determining a degradation in packet transmission performance while operating in the second mode based on a performance indicator for a period of time. The method comprises performing the second switching to switch from the second mode to the first mode based on determining the degradation in the packet transmission performance and determining that performing the second switching is allowed. The method comprises transmitting one or more packets to the one or more UEs while operating in the first mode.

In some embodiments, the first mode is a transmit antenna selection mode and the second mode is a precoding matrix indicator mode or ii) the first mode is a precoding matrix indicator mode and the second mode is a transmit antenna selection mode.

In some embodiments, the determining the degradation in the packet transmission performance based on the performance indicator for the period of time comprises: i) determining that a measured throughput after the first switching is lower than a measured throughput before the first switching, ii) a block error rate increases after the first switching, or ii) a predicted throughput of the first mode is greater than a measured throughput of the second mode.

In some embodiments, the method further comprises performing an update to the second mode during a time delay period; and performing the second switching from the second mode to the first mode after the time delay period.

In some embodiments, the time delay period is fixed.

In some embodiments, the time delay period varies based on an amount of the degradation in the packet transmission performance.

In some embodiments, performance indicator is a block error rate, a measured throughput, or an average outer-loop rate control value.

In some embodiments, the first threshold or the second threshold vary based on a current system load or a traffic type of a user equipment (UE).

In some embodiments, the method further comprises repeatedly checking during a time period whether performing the second switching is allowed.

In some embodiments, the period of time is greater than a third threshold.

### BRIEF DESCRIPTION OF THE DRAWINGS

FIG. 1 shows an example of a wireless network in accordance with an embodiment.

FIGS. 2A and 2B illustrate example wireless transmit and receive paths in accordance with an embodiment.

FIG. 3A illustrates an example user equipment (UE) in accordance with an embodiment.

FIG. 3B illustrates an example gNodeB (gNB) in accordance with an embodiment.

FIG. 4 illustrates a beamforming architecture in accordance with an embodiment.

FIG. 5 illustrates a system for throughput prediction based multiple-input multiple-output (MIMO) mode switch in accordance with an embodiment.

FIG. 6 illustrates an example of fast switching in accordance with an embodiment.

FIG. 7 illustrates an example of fast switching using a threshold in accordance with an embodiment.

FIG. 8 illustrates an example fast switching based on a key performance indicator (KPI) degradation in accordance with an embodiment.

FIG. 9 illustrates an example of checking KPI to perform fast switching in accordance with an embodiment.

FIG. 10 illustrates an example of performing an update related to a current MIMO mode in accordance with an embodiment.

FIG. 11 illustrates a flow chart of an example process of fast switching in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IOT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed.

The 5G communication system is considered to be implemented to include higher frequency (mmWave) bands, such as 28 GHz or 60 GHz bands or, in general, above 6 GHz bands, so as to accomplish higher data rates, or in lower frequency bands, such as below 6 GHZ, to enable robust coverage and mobility support. Aspects of the present disclosure may be applied to deployment of 5G communication systems, 6G or even later releases which may use THz bands. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (COMP), reception-end interference cancellation and the like.

In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

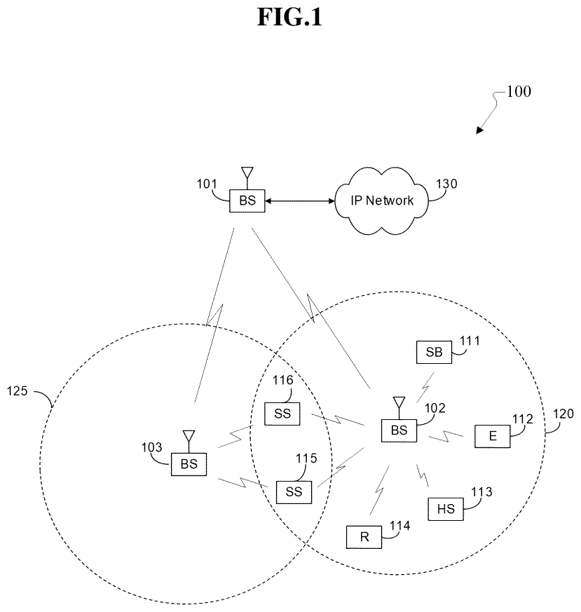

FIG. 1 illustrates an example wireless network 100 according to this disclosure. The embodiment of the wireless network 100 shown in FIG. 1 is for illustration only. Other embodiments of the wireless network 100 can be used without departing from the scope of this disclosure.

The wireless network 100 includes an gNodeB (gNB) 101, an gNB 102, and an gNB 103. The gNB 101 communicates with the gNB 102 and the gNB 103. The gNB 101 also communicates with at least one Internet Protocol (IP) network 130, such as the Internet, a proprietary IP network, or other data network.

Depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an gNB, whether the UE is a mobile device (such as a mobile telephone or smartphone) or is normally considered a stationary device (such as a desktop computer or vending machine).

The gNB 102 provides wireless broadband access to the network 130 for a first plurality of user equipments (UEs) within a coverage area 120 of the gNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G, long-term evolution (LTE), LTE-A, WiMAX, or other advanced wireless communication techniques.

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of BS 101, BS 102 and BS 103 include 2D antenna arrays as described in embodiments of the present disclosure. In some embodiments, one or more of BS 101, BS 102 and BS 103 support the codebook design and structure for systems having 2D antenna arrays.

Although FIG. 1 illustrates one example of a wireless network 100, various changes may be made to FIG. 1. For example, the wireless network 100 can include any number of gNBs and any number of UEs in any suitable arrangement. Also, the gNB 101 can communicate directly with any number of UEs and provide those UEs with wireless broadband access to the network 130. Similarly, each gNB 102-103 can communicate directly with the network 130 and provide UEs with direct wireless broadband access to the network 130. Further, the gNB 101, 102, and/or 103 can provide access to other or additional external networks, such as external telephone networks or other types of data networks.

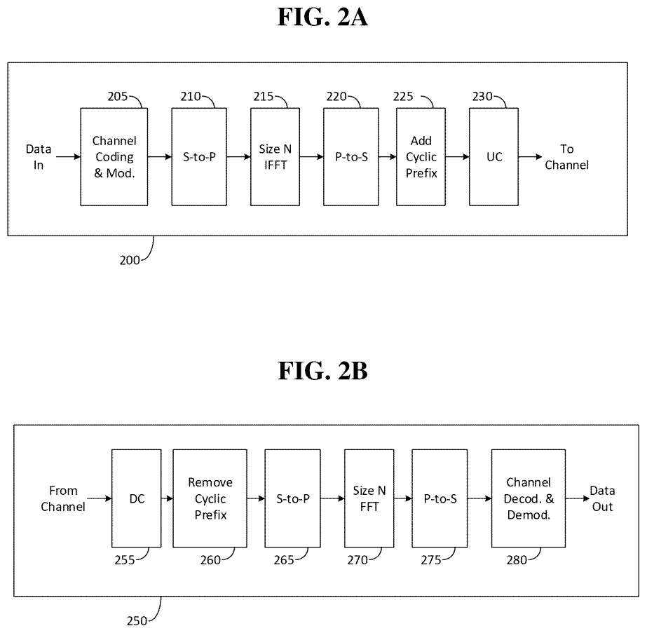

FIGS. 2A and 2B illustrate example wireless transmit and receive paths according to this disclosure. In the following description, a transmit path 200 may be described as being implemented in an gNB (such as gNB 102), while a receive path 250 may be described as being implemented in a UE (such as UE 116). However, it will be understood that the receive path 250 can be implemented in an gNB and that the transmit path 200 can be implemented in a UE. In some embodiments, the receive path 250 is configured to support the codebook design and structure for systems having 2D antenna arrays as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

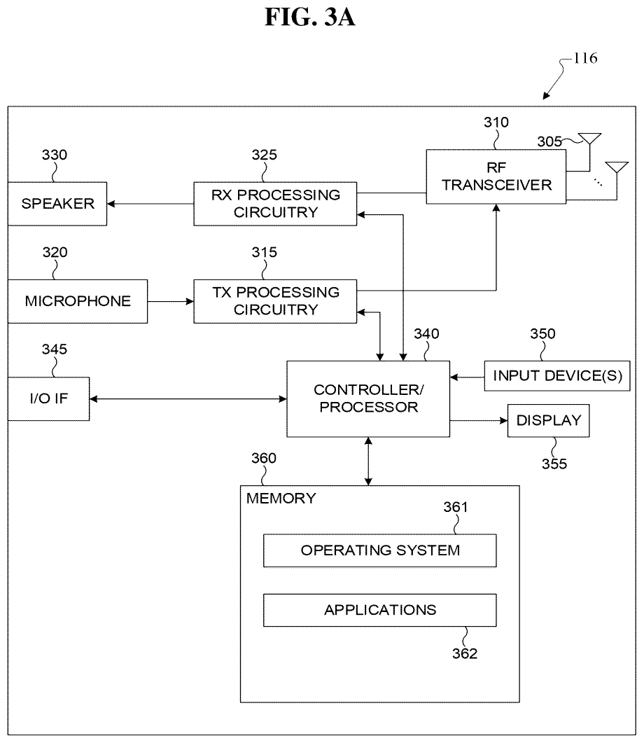

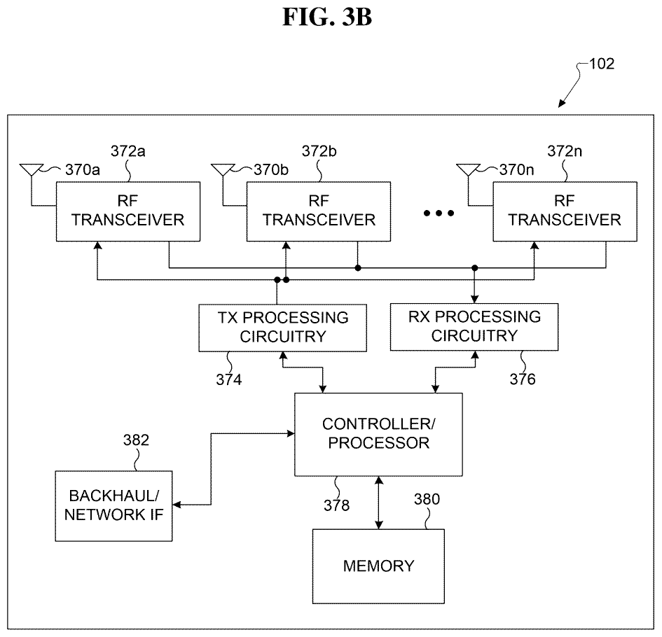

FIG. 3A illustrates an example UE 116 according to this disclosure. The embodiment of the UE 116 illustrated in FIG. 3A is for illustration only, and the UEs 111-115 of FIG. 1 can have the same or similar configuration. However, UEs come in a wide variety of configurations, and FIG. 3A does not limit the scope of this disclosure to any particular implementation of a UE.

The UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an gNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360, such as operations for channel quality measurement and reporting for systems having 2D antenna arrays as described in embodiments of the present disclosure as described in embodiments of the present disclosure. The main processor 340 can move data into or out of the memory 360 as required by an executing process. In some embodiments, the main processor 340 is configured to execute the applications 362 based on the OS program 361 or in response to signals received from gNBs or an operator. The main processor 340 is also coupled to the I/O interface 345, which provides the UE 116 with the ability to connect to other devices such as laptop computers and handheld computers. The I/O interface 345 is the communication path between these accessories and the main controller 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites. The memory 360 is coupled to the main processor 340. Part of the memory 360 can include a random access memory (RAM), and another part of the memory 360 can include a Flash memory or other read-only memory (ROM).

Although FIG. 3A illustrates one example of UE 116, various changes may be made to FIG. 3A. For example, various components in FIG. 3A can be combined, further subdivided, or omitted and additional components can be added according to particular needs. As a particular example, the main processor 340 can be divided into multiple processors, such as one or more central processing units (CPUs) and one or more graphics processing units (GPUs). Also, while FIG. 3A illustrates the UE 116 configured as a mobile telephone or smartphone, UEs can be configured to operate as other types of mobile or stationary devices.

FIG. 3B illustrates an example gNB 102 according to this disclosure. The embodiment of the gNB 102 shown in FIG. 3B is for illustration only, and other gNBs of FIG. 1 can have the same or similar configuration. However, gNBs come in a wide variety of configurations, and FIG. 3B does not limit the scope of this disclosure to any particular implementation of an gNB. It is noted that gNB 101 and gNB 103 can include the same or similar structure as gNB 102.

As shown in FIG. 3B, the gNB 102 includes multiple antennas 370a-370n, multiple RF transceivers 372a-372n, transmit (TX) processing circuitry 374, and receive (RX) processing circuitry 376. In certain embodiments, one or more of the multiple antennas 370a-370n include 2D antenna arrays. The gNB 102 also includes a controller/processor 378, a memory 380, and a backhaul or network interface 382.

The RF transceivers 372a-372n receive, from the antennas 370a-370n, incoming RF signals, such as signals transmitted by UEs or other gNBs. The RF transceivers 372a-372n down-convert the incoming RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing.

The TX processing circuitry 374 receives analog or digital data (such as voice data, web data, e-mail, or interactive video game data) from the controller/processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-converts the baseband or IF signals to RF signals that are transmitted via the antennas 370a-370n.

The controller/processor 378 can include one or more processors or other processing devices that control the overall operation of the gNB 102. For example, the controller/processor 378 can control the reception of forward channel signals and the transmission of reverse channel signals by the RF transceivers 372a-372n, the RX processing circuitry 376, and the TX processing circuitry 374 in accordance with well-known principles. The controller/processor 378 can support additional functions as well, such as more advanced wireless communication functions. For instance, the controller/processor 378 can perform the blind interference sensing (BIS) process, such as performed by a BIS algorithm, and decodes the received signal subtracted by the interfering signals. Any of a wide variety of other functions can be supported in the gNB 102 by the controller/processor 378. In some embodiments, the controller/processor 378 includes at least one microprocessor or microcontroller.

The controller/processor 378 is also capable of executing programs and other processes resident in the memory 380, such as a basic OS. The controller/processor 378 is also capable of supporting channel quality measurement and reporting for systems having 2D antenna arrays as described in embodiments of the present disclosure. In some embodiments, the controller/processor 378 supports communications between entities, such as web RTC. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 can support communications over any suitable wired or wireless connection(s). For example, when the gNB 102 is implemented as part of a cellular communication system (such as one supporting 5G, LTE, or LTE-A), the interface 382 can allow the gNB 102 to communicate with other gNBs over a wired or wireless backhaul connection. When the gNB 102 is implemented as an access point, the interface 382 can allow the gNB 102 to communicate over a wired or wireless local area network or over a wired or wireless connection to a larger network (such as the Internet). The interface 382 includes any suitable structure supporting communications over a wired or wireless connection, such as an Ethernet or RF transceiver.

The memory 380 is coupled to the controller/processor 378. Part of the memory 380 can include a RAM, and another part of the memory 380 can include a Flash memory or other ROM. In certain embodiments, a plurality of instructions, such as a BIS algorithm is stored in memory. The plurality of instructions are configured to cause the controller/processor 378 to perform the BIS process and to decode a received signal after subtracting out at least one interfering signal determined by the BIS algorithm.

As described in more detail below, the transmit and receive paths of the gNB 102 (implemented using the RF transceivers 372a-372n, TX processing circuitry 374, and/or RX processing circuitry 376) support communication with aggregation of FDD cells and TDD cells.

Although FIG. 3B illustrates one example of an gNB 102, various changes may be made to FIG. 3B. For example, the gNB 102 can include any number of each component shown in FIG. 3. As a particular example, an access point can include a number of interfaces 382, and the controller/processor 378 can support routing functions to route data between different network addresses. As another particular example, while shown as including a single instance of TX processing circuitry 374 and a single instance of RX processing circuitry 376, the gNB 102 can include multiple instances of each (such as one per RF transceiver).

Rel.13 LTE supports up to 16 CSI-RS antenna ports which enable a gNB to be equipped with a large number of antenna elements (such as 64 or 128). In this case, a plurality of antenna elements is mapped onto one CSI-RS port. Furthermore, up to 32 CSI-RS ports will be supported in Rel.14 LTE. For next generation cellular systems such as 5G, it is expected that the maximum number of CSI-RS ports remain more or less the same.

For mm Wave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mm Wave frequencies).

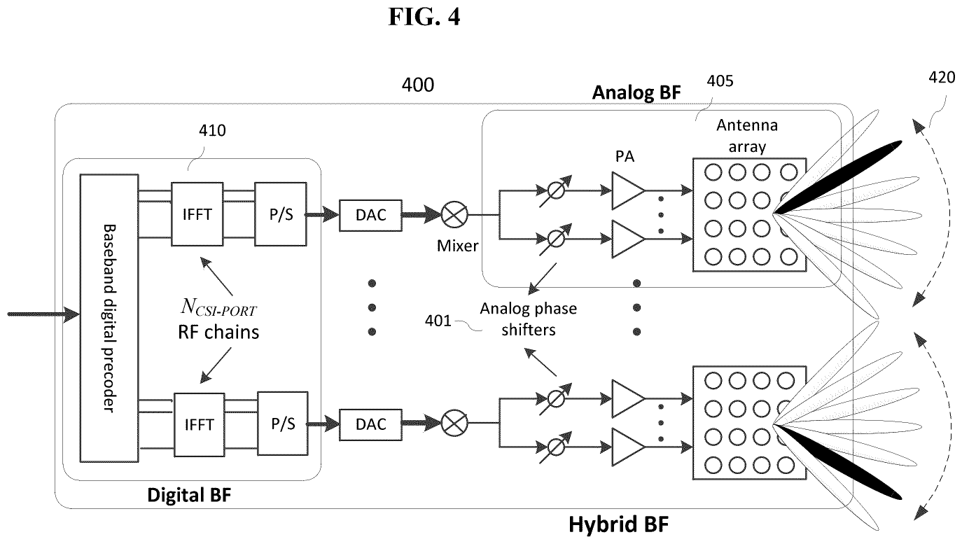

FIG. 4 illustrates a beamforming architecture in accordance an embodiment. In particular, one CSI-RS port is mapped onto a large number of antenna elements which can be controlled by a bank of analog phase shifters 401. One CSI-RS port can then correspond to one sub-array which produces a narrow analog beam through analog beamforming 405. This analog beam can be configured to sweep across a wider range of angles 420 by varying the phase shifter bank across symbols or subframes or slots (wherein a subframe or a slot comprises a collection of symbols and/or can comprise a transmission time interval). The number of sub-arrays (equal to the number of RF chains) is the same as the number of CSI-RS ports N_{CSI-PORT}. A digital beamforming unit 410 performs a linear combination across N_{CSI-PORT} analog beams to further increase precoding gain. While analog beams are wideband (hence not frequency-selective), digital precoding can be varied across frequency sub-bands or resource blocks.

Embodiments in accordance with this disclosure may check a beamforming (BF) mode used for a current downlink (DL) transmission in order to determine whether to switch between MIMO modes. In some embodiments, the MIMO modes may include a transmit antenna selection (TAS) throughput prediction mode and a precoding matrix indicator (PMI) mode, among other modes. In some embodiments, the frequency of checking the MIMO mode may depend on performance requirements and/or the available computational complexity. In some embodiments, the determination of whether to change a MIMO mode may be monitored every DL slots. In some embodiments, the MIMO mode of each UE may be checked every K DL slot, where K≥1. In some embodiments, K may be a fixed number that may be determined by the system capability. In certain embodiments, K may vary according to a system load, among other factors. In some embodiments, a smaller K may be applied if the system load is low, otherwise, a larger K may be used.

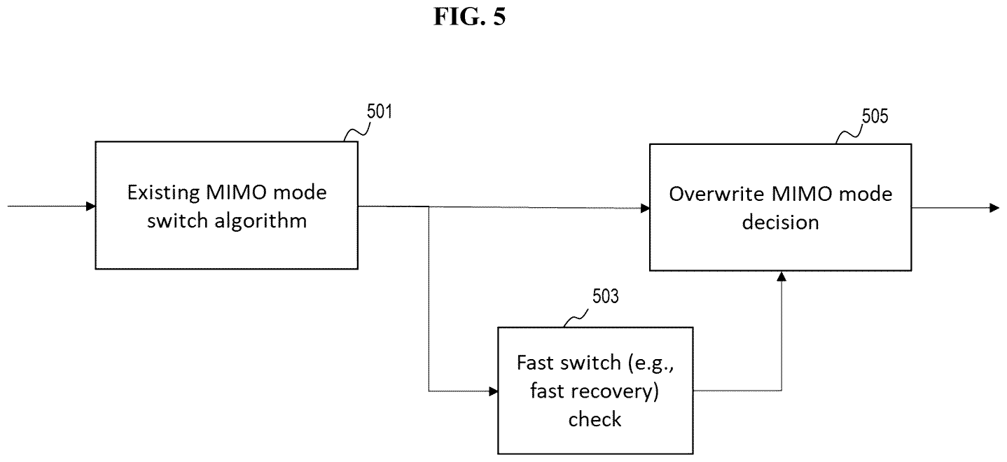

FIG. 5 illustrates a system for throughput prediction based MIMO mode switch in accordance with an embodiment. As illustrated, the system performs a MIMO mode switch algorithm 501 to determine a MIMO mode 505. In some embodiments, the MIMO modes may include a transmit antenna selection (TAS) throughput prediction mode and a precoding matrix indicator (PMI) mode, among other modes. Based on the determined MIMO mode from the existing MIMO mode switch algorithm 501, the system performs a fast switch check 503 (e.g., fast recovery) which determines whether or not to perform the overwrite of the MIMO mode decision 505, in particular to overwrite the MIMO mode output by the existing MIMO mode switch algorithm 501. In some embodiments, a fast switch is a switch from a current MIMO mode (e.g., TAS throughput prediction mode or PMI mode) to a different MIMO mode from the available MIMO modes based on a determination that there is a degradation in one or more performance indicators. Accordingly, performing a MIMO mode switch, or fast switch, will allow the system to quickly recover from a performance degradation. For example, if the system is operating in a TAS throughput prediction mode, performing a fast switch will switch the MIMO mode to a PMI mode. Likewise, if the system is operating in a PMI mode, performing a fast switch will switch the MIMO mode to a TAS throughput prediction mode. Accordingly, a fast switch will switch a MIMO mode from a current mode to a different mode based on the performance indicator.

In some embodiments, the fast switch may check one or more performance indicators in order to determine whether to overwrite 505 the determined MIMO mode provided by the existing MIMO mode switch algorithm 501. In some embodiments, the performance indicator can be any combination of performance metrics of the UE including one or more of a block error rate (BLER), a BLER of an initial transmission, a measured throughput, a measured throughput of an initial transmission, an average outer-loop rate control (OLRC) value, among others.

In some embodiments, the system may check whether fast switching from a current MIMO mode to a different MIMO mode is allowed. In some embodiments, the system may check the difference between the current time and the time when the most recent fast switching (e.g., fast recovery) occurred, denoted by

$${Δ}_{t}^{F R} ,$$

where FR is a time most recent fast recovery (FR) or fast switch. If the difference in time is greater than a threshold (e.g.,

$${Δ}_{t}^{F R} \geq {T}_{th}^{F R} ,$$

where

$${T}_{th}^{F R} > 0 ) ,$$

then fast switching (e.g., fast recovery) is allowed. Otherwise, the fast switching is not allowed. The terms fast recovery and fast switching as described herein may be used interchangeably to refer to operations whereby a system switches to a different mode from a current mode based on degradation in one or more performance indicators.

In some embodiments, the system may check a number of packets, denoted by Nₚₖₜ, sent since the most recent fast switching (e.g., fast recovery) occurred. If the number of packets is greater than a threshold (e.g.,

$${N}_{pkt} \geq {N}_{th}^{F R} ,$$

where

$${N}_{th}^{F R} > 0 ) ,$$

then the fast switching (e.g., recovery) is allowed. Otherwise, the fast switching is not allowed.

In some embodiments, the system may compare a key performance indicator (KPI) related to a MIMO mode and may determine whether fast switching needs to be performed if the fast switching is allowed. In some embodiments, the KPI degradation is only checked right after the most recent MIMO mode switch happens. In certain embodiments, the fast switching is checked after a certain time period after the most recent MIMO mode switch (e.g., T₁ mili-seconds after the most recent MIMO mode switch). In some embodiments, the fast switching is checked if a number of packets (e.g., N₁ packets) has been transmitted after the most recent MIMO mode switch.

In some embodiments, the KPI can be any combination of performance metrics of the UE including one or more of a block error rate (BLER), a BLER of an initial transmission, a measured throughput, a measured throughput of an initial transmission, an average outer-loop rate control (OLRC) value, among others.

In some embodiments, the KPI of the UE both before and after the most recent MIMO mode switch may be compared. In some embodiments, the fast switching may be performed if the KPI after the most recent MIMO mode switch is lower than that before the most recent MIMO mode switch by some margin. In some embodiments, a fast switching may be performed if a BLER increases or a measured throughput drops after the most recent switch. In some embodiments, the fast switching may be performed if the predicted throughput of the unselected MIMO mode is greater than the measured throughput of the current MIMO mode by some margin. In some embodiments, the KPI of the UE after the most recent MIMO mode may be used for determining fast switching.

In some embodiments, the MIMO mode before the most recent switch may be applied again immediately after the decision to perform the fast switching. In some embodiments, the MIMO mode before the most recent switch may be applied again after some time delay, denoted by T₂. In some embodiments, the MIMO mode before the most recent switch may not be applied again unless one or more conditions are satisfied, including i) link-adaptation converges and/or ii) one or more (e.g., all) possible updates related to the current MIMO mode are completed.

In some embodiments, a possible update related to the current MIMO mode may be performed within a reduced time. The reduced amount may depend on one or more factors including but not limited to the periodicity of the input for the update, the current system load and/or the KPI degradation, among other factors. In some embodiments, the possible update related to the current MIMO mode may be performed for a longer time with a given larger KPI degradation.

In some embodiments, fixed thresholds, including fixed

$${T}_{th}^{F R} , {N}_{th}^{F R} ,$$

T₁, N₁, T₂ may applied for one or more UEs (e.g., all UEs) in the system. In certain embodiments, at least one of thresholds, including

$${T}_{th}^{F R} , {N}_{th}^{F R} ,$$

T₁, N₁, T₂ may vary depending on one or more factors including but not limited to current system load, traffic type of the UE, UE channel, link-adaptation status, among other factors.

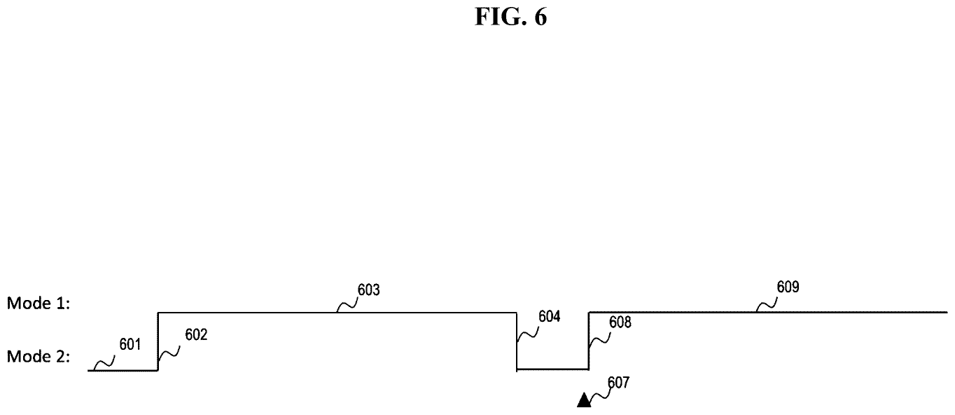

FIG. 6 illustrates a fast switching in accordance with an embodiment. In some embodiments, the fast switching may be allowed if the time difference between the current time and the time when the most recent fast switching is larger than a threshold. In some embodiments, the fast switching may be allowed if the number of packets transmitted since the last most recent fast switching exceeds a threshold. As illustrated in FIG. 6, the system is initially in a mode 2 for a time period 601 (e.g., a TAS throughput prediction mode or a PMI mode) and performs a fast switching 602 to a different mode 1 for a time period 603. For example, if mode 2 is TAS throughput prediction mode, then mode 1 is PMI mode. Likewise, if mode 2 is PMI mode, then mode 1 is TAS throughput prediction mode. During time period 603 while operating in mode 1, fast switching does not happen during this time period 603 or a number of packets transmitted during the time period of 603 is larger than some threshold. Subsequently, the system performs a switch 604 from mode 1 to mode 2. Then, the system checks at time 607 whether fast switching is allowed. As illustrated, the fast switching may be allowed i) if the time difference between the current time and the time when the most recent fast switching, which is fast switching 602, occurred is larger than a threshold, or ii) the number of packets transmitted since the last most recent fast switching, which is fast switching 602, exceeds a threshold. As one or more of these conditions is satisfied, the system is able to perform the fast switching. Accordingly, the system performs the fast switching 608 from mode 2 to mode 1 and operates in mode 1 for a subsequent period of time 609. For example, the fast switching 608 may be performed if the KPI after the most recent MIMO mode switch 604 is lower than the KPI before the most recent MIMO mode switch 604 by some margin.

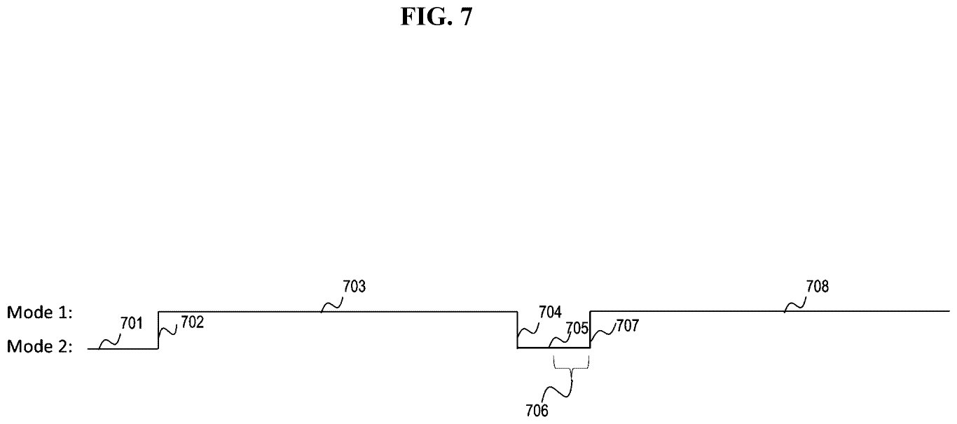

FIG. 7 illustrates an example of checking whether fast switching is allowed using a threshold in accordance with an embodiment. In some embodiments, the threshold can be a fixed number in the network, cell specific, or UE specific. In some embodiments, the threshold can be dependent on a current system status, including a system load, UE traffic type, among other factors. In some embodiments, checking whether fast switching is allowed can be performed one or multiple times after a most recent MIMO mode switch. As illustrated in FIG. 7, the system is initially operating in a mode 2 for a time period 701 and performs a fast switch 702 to a mode 1 and operates in mode 1 for a time period 703. As indicated, i) fast switching does not happen for a time period 703 while in mode 1 or ii) a number of packets transmitted during the time period 703 while in mode 1 is larger than some threshold. The system performs a switch 704 to mode 2 for a time period 705. The system checks during time period 706 whether fast switching is allowed. The system may repeatedly check during time period 706 whether fast switching is allowed after the most recent MIMO mode switch 704. As illustrated, the fast switching may be allowed i) if the time difference between the current time and the time when the most recent fast switching, which is fast switching 702, occurred is larger than a threshold, or ii) the number of packets transmitted since the last most recent fast switching, which is fast switching 702, exceeds a threshold. As one or more of these conditions is satisfied, the system is able to perform the fast switching. Accordingly, the system performs a fast switch 707 back to mode 1 and operates in mode 1 for a time period 708. For example, the fast switching 707 may be performed if there is a degradation in a KPI after the most recent MIMO mode switch 704 compared to before the most recent MIMO mode switch 707 by some margin.

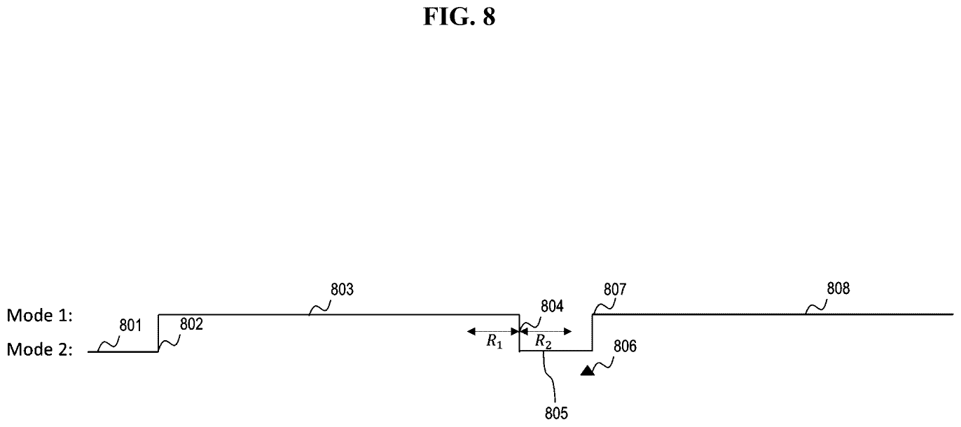

FIG. 8 illustrates an example of triggering fast switching based on a KPI degradation in accordance with an embodiment. In some embodiments, fast switching may be triggered if a KPI degradation is observed. In some embodiments, the KPI can be a BLER or measured throughput, R, obtained before and after a most recent switch, among other indicators. If the measured throughput before a most recent switch, R₁, is greater than a measured throughput after the most recent switch, R₂, then a fast switching will be triggered. As illustrated in FIG. 8, the system initially operates in mode 2 of a MIMO mode for a time period 801, and performs a fast switch 802 to a mode 1 of a MIMO mode and operates in mode 1 for a time period 803. The system operates in mode 1 for a time period 803 where i) fast switching does not happen or ii) a number of packets transmitted in this time period 803 is larger than a threshold. The system performs a switch 804 to mode 2 and operates in mode 2 for a time period 805. The system checks at time 806 whether fast switching is allowed. As illustrated, the fast switching may be allowed i) if the time difference between the current time and the time when the most recent fast switching, which is fast switching 802, occurred is larger than a threshold, or ii) the number of packets transmitted since the most recent fast switching, which is fast switching 802, exceeds a threshold. As one or more of these conditions is satisfied, the system is able to perform a fast switching. The system performs a fast switching 807 and switches to mode 1 for a time period 808. In particular, the system may determine that the throughput before the most recent switch 804, R₁ is greater than the throughput after the most recent switch 804, R₂, and thus the system performs fast switching 807 back to mode 1. In some embodiments, the system may use a KPI to determine whether to perform fast switching. In particular, a KPI degradation may occur when a measured throughput before a most recent switch is larger than after the switch, a BLER increases after the most recent switch, and/or a predicted throughput of the unselected MIMO mode is higher than the measured throughput of the selected MIMO mode, among other factors.

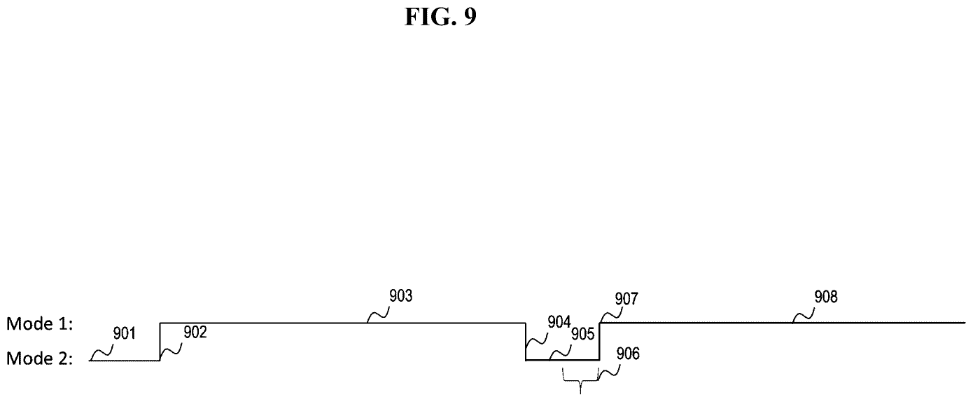

FIG. 9 illustrates an example of checking KPI to perform fast switching in accordance with an embodiment. In some embodiments, a system may check whether fast switching is allowed one or more times after a most recent MIMO mode switch. In some embodiments, the system may trigger fast switching if a KPI degradation is observed for some time period that exceeds a threshold. As illustrated in FIG. 9, the system is initially operating in mode 2 for a time period 901. The system performs a fast switching 902 from mode 2 to mode 1 where it operates for a time period 903. During the time period 903 while operating in mode 1, the system i) does not perform any fast switching or ii) a number of packets transmitted during time period 903 is larger than a threshold. The system performs a switch 904 from mode 1 to mode 2 and operates in mode 2 for a time period 905. The system checks during time period 906 whether fast switching is allowed. In particular, the system may check during time period 906 whether fast switching is allowed one or more times after a most recent MIMO mode switch 904. As illustrated, the fast switching may be allowed i) if the time difference between the current time and the time when the most recent fast switching, which is fast switching 902, occurred is larger than a threshold, or ii) the number of packets transmitted since the last most recent fast switching, which is fast switching 902, exceeds a threshold. As one or more of these conditions is satisfied, the system is able to perform the fast switching. Accordingly, the system performs a fast switch 907 back to mode 1 and operates in mode 1 for a time period 908. In particular, the fast switching 907 may be performed if there is a degradation in a KPI that is observed for a time period that exceeds a threshold after the most recent MIMO mode switch 904 compared to before the most recent MIMO mode switch 904 by some margin. Accordingly, the system performs a fast switching 907 and switches to mode 1 and operates in mode 1 for a time period 908.

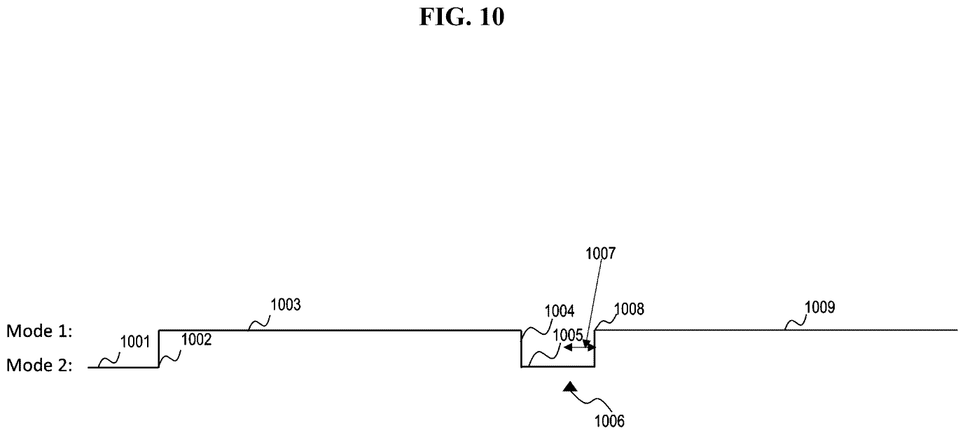

FIG. 10 illustrates an example of performing an update related to a current MIMO mode in accordance with an embodiment. In some embodiments, a fast switching may be delayed for a time period after a decision is made to perform the fast switching, in particular, the system may need some time to update the information regarding the current MIMO mode. In some embodiments, the delay may be a fixed number across the network, cell specific, or UE specific. In some embodiments, different delays may be applied based on a system load, UE traffic status, and/or amount of KPI degradation. As illustrated in FIG. 10, the system is initially operating in mode 2 of a MIMO mode for a time period 1001. The system performs a fast switch 1002 to mode 1 and operates in mode 1 for a time period 1003. During time period 1003, i) the system does not perform any fast switching or ii) a number of packets transmitted is larger than a threshold. The system performs a switch 1004 to mode 2 and operates in mode 2 for a time period 1005. At time 1006 the system checks whether fast switching is allowed. As illustrated there is a delay 1007 for fast switching. As illustrated, the fast switching may be allowed i) if the time difference between the current time and the time when the most recent fast switching, which is fast switching 1002, occurred is larger than a threshold, or ii) the number of packets transmitted since the last most recent fast switching, which is fast switching 1002, exceeds a threshold. As one or more of these conditions is satisfied, the system is able to perform the fast switching. However, the system may delay performing the fast switching for a time period after a decision is made to perform the fast switching in order to update information regarding a current MIMO mode. After the delay 1007, the system performs a fast switching 1008 and switches from mode 2 to mode 1 and operates in mode 1 for a time period 1009.

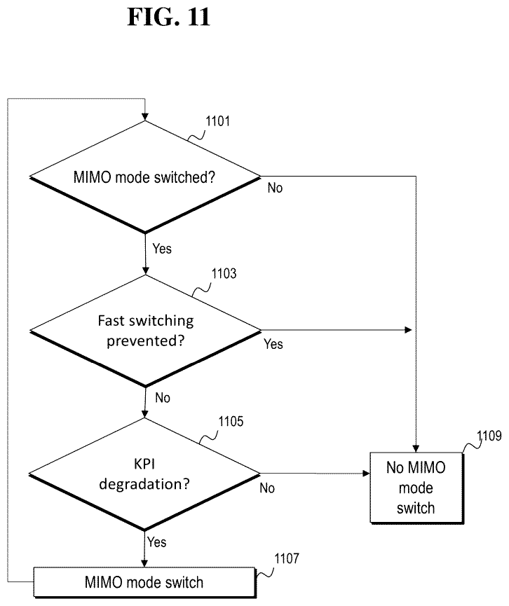

FIG. 11 illustrates a flow chart of an example process 1100 of fast switching in accordance with an embodiment. Although one or more operations are described or shown in particular sequential order, in other embodiments the operations may be rearranged in a different order, which may include performance of multiple operations in at least partially overlapping time periods.

The process 1100, in operation 1101, the system determines whether there is a MIMO mode switch. If the system determines there is no MIMO mode switch, the process proceeds to operation 1109 and performs no MIMO mode switch. If the system determines that there is a MIMO mode switch, the process proceeds to operation 1103.

In operation 1103, the system determines whether there is a switching prevention. In some embodiments, the system may check the difference between the current time and the time when the most recent fast switching (e.g., recovery) occurred, denoted by

$${Δ}_{t}^{F R} .$$

If the difference in time is greater than a threshold (e.g.,

$${Δ}_{t}^{F R} \geq {T}_{th}^{F R} ,$$

where

$${T}_{th}^{F R} > 0 ) ,$$

then the fast switching (recovery) is allowed and there is no switching prevention. Otherwise, the fast switching is not allowed and there is switching prevention. In some embodiments, the system may check a number of packets, denoted by Nₚₖₜ, sent since the most recent fast switching (e.g., recovery) occurred. If the number of packets is greater than a threshold (e.g.,

$${N}_{pkt} \geq {N}_{th}^{F R} ,$$

where

$${N}_{th}^{F R} > 0 ) ,$$

then the fast switching (e.g., recovery) is allowed, and there is no fast switching prevention. Otherwise, the fast switching is not allowed and there is fast switching prevention. If the system determines that there is fast switching prevention, the system proceeds to operation 1109 and does not perform a MIMO mode switch. If the system determines that there is no fast switching prevention, the process proceeds to operation 1105.

In operation 1105, the system determines whether there is a KPI degradation. If in operation 1105, the system determines there is no KPI degradation, the process proceeds to operation 1109 and does not perform a MIMO mode switch. If in operation 1105, the system determines there is a KPI degradation, the process proceeds to operation 1107 and performs a MIMO mode switch. In some embodiments, the KPI can be any combination of performance metrics of the UE including one or more of a block error rate (BLER), a BLER of an initial transmission, a measured throughput, a measured throughput of an initial transmission, an average outer-loop rate control (OLRC) value, among others. In some embodiments, the KPI of the UE both before and after the most recent MIMO mode switch may be compared. In some embodiments, the fast switching may be performed if the KPI after the most recent MIMO mode switch is lower than that before the most recent MIMO mode switch by some margin. For example, BLER increases or measured throughput drops after the most recent switch. In some embodiments, the fast switching may be performed if the predicted throughput of the unselected MIMO mode is greater than the measured throughput of the current MIMO mode by some margin. In some embodiments, the KPI of the UE after the most recent MIMO mode may be used for determining fast switching.

In operation 1107, the system performs the MIMO mode switch. In some embodiments, the MIMO mode before the most recent switch may be applied again immediately after the fast switching decision. In some embodiments, the MIMO mode before the most recent switch may be applied again after some time delay, denoted by T₂. In some embodiments, the MIMO modes may include a transmit antenna selection (TAS) throughput prediction mode and a precoding matrix indicator (PMI) mode, among other modes.

Embodiments in accordance with this disclosure may check performance of a current MIMO mode used for a transmission in order to determine whether to perform fast switching between MIMO modes, which quickly switches to an optimal MIMO mode and enhances performance of wireless communications by reducing a time during which transmissions are transmitted in an inferior MIMO mode.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A base station (BS) in a wireless network, comprising:
a memory; and
a processor coupled to the memory, the processor configured to:
perform a first switching from a first mode to a second mode;
transmit one or more packets to one or more user equipment (UEs) while operating in the second mode;
determine that performing a second switching is allowed based on i) whether a time period after the first switching is greater than a first threshold or ii) whether a number of packets transmitted from the BS after the first switching is greater than a second threshold;
determine a degradation in packet transmission performance while operating in the second mode based on a performance indicator for a period of time;
perform the second switching to switch from the second mode to the first mode based on determining the degradation in the packet transmission performance and determining that performing the second switching is allowed; and
transmit one or more packets to the one or more UEs while operating in the first mode.

2. The BS of claim 1, wherein i) the first mode is a transmit antenna selection mode and the second mode is a precoding matrix indicator mode or ii) the first mode is a precoding matrix indicator mode and the second mode is a transmit antenna selection mode.

3. The BS of claim 1, wherein the determining the degradation in the packet transmission performance based on the performance indicator for the period of time comprises: i) determining that a measured throughput after the first switching is lower than a measured throughput before the first switching, ii) a block error rate increases after the first switching, or iii) a predicted throughput of the first mode is greater than a measured throughput of the second mode.

4. The BS of claim 1, wherein the processor is further configured to:
perform an update to the second mode during a time delay period; and
perform the second switching from the second mode to the first mode after the time delay period.

5. The BS of claim 4, wherein the time delay period is fixed.

6. The BS of claim 4, wherein the time delay period varies based on an amount of the degradation in the packet transmission performance.

7. The BS of claim 1, wherein the performance indicator is a block error rate, a measured throughput, or an average outer-loop rate control value.

8. The BS of claim 1, wherein the first threshold or the second threshold vary based on a current system load or a traffic type of a user equipment (UE).

9. The BS of claim 1, wherein the processor is further configured to:
repeatedly check during a time period whether performing the second switching is allowed.

10. The BS of claim 1, wherein the period of time is greater than a third threshold.

11. A computer-implemented method for wireless communication by a base station (BS) in a wireless network, comprising:
performing a first switching from a first mode to a second mode;
transmitting one or more packets to one or more user equipment (UEs) while operating in the second mode;
determining that performing a second switching is allowed based on i) whether a time period after the first switching is greater than a first threshold or ii) whether a number of packets transmitted from the BS after the first switching is greater than a second threshold;
determining a degradation in packet transmission performance while operating in the second mode based on a performance indicator for a period of time;
performing the second switching to switch from the second mode to the first mode based on determining the degradation in the packet transmission performance and determining that performing the second switching is allowed; and
transmitting one or more packets to the one or more UEs while operating in the first mode.

12. The computer-implemented method of claim 11, wherein i) the first mode is a transmit antenna selection mode and the second mode is a precoding matrix indicator mode or ii) the first mode is a precoding matrix indicator mode and the second mode is a transmit antenna selection mode.

13. The computer-implemented method of claim 11, wherein the determining the degradation in the packet transmission performance based on the performance indicator for the period of time comprises: i) determining that a measured throughput after the first switching is lower than a measured throughput before the first switching, ii) a block error rate increases after the first switching, or iii) a predicted throughput of the first mode is greater than a measured throughput of the second mode.

14. The computer-implemented method of claim 11, further comprising:
performing an update to the second mode during a time delay period; and
performing the second switching from the second mode to the first mode after the time delay period.

15. The computer-implemented method of claim 14, wherein the time delay period is fixed.

16. The computer-implemented method of claim 14, wherein the time delay period varies based on an amount of the degradation in the packet transmission performance.

17. The computer-implemented method of claim 11, wherein the performance indicator is a block error rate, a measured throughput, or an average outer-loop rate control value.

18. The computer-implemented method of claim 11, wherein the first threshold or the second threshold vary based on a current system load or a traffic type of a user equipment (UE).

19. The computer-implemented method of claim 11, further comprising:
repeatedly checking during a time period whether performing the second switching is allowed.

20. The computer-implemented method of claim 11, wherein the period of time is greater than a third threshold.
